(19) United States
(12) Patent Application Publication
(10) Pub. No.: US 2014/0012509 A1
(43) Pub. Date: Jan. 9, 2014

(54) METHODS AND SYSTEMS FOR SYNCHRONIZATION AND DISTRIBUTION OF MULTIPLE PHYSIOLOGICAL AND PERFORMANCE MEASURES

(71) Applicant: Daniel Barber, Orlando, FL (US)

(72) Inventor: Daniel Barber, Orlando, FL (US)

(21) Appl. No.: 13/543,555

(22) Filed: Jul. 6, 2012

(51) Int. Cl. G06F 19/00

(52) U.S. Cl. 702/19

(57) ABSTRACT

Methods and systems are disclosed including receiving, by circuitry of a computer, physiological data comprising physiological information gathered by a physiological sensor regarding a subject, the subject having physiological reactions to an event that is external to the subject, wherein at least one of the physiological data also comprises a first time at which the physiological data was recorded, wherein the first time is based on a global reference time frame; receiving non-physiological data comprising information regarding the external event, wherein at least one of the non-physiological data also comprises a second time at which the non-physiological data was recorded, wherein the second time is based on the global reference time frame; correlating the physiological data with the non-physiological data based on the first and second times; and generating physiological reaction data indicative of a physiological reaction of the subject to the external event.

### STATEMENT REGARDING FEDERALLY SPONSORED RESEARCH OR DEVELOPMENT

This invention was made with government support under W91CRB08D0015 awarded by the United States Army Research, Development and Engineering Command. The Government has certain rights in the invention.

### CROSS-REFERENCE TO RELATED APPLICATIONS

Not applicable.

### FIELD OF THE DISCLOSURE

The disclosure generally relates to methods and systems that correlate physiological sensor data and non-physiological sensor data and systems. More particularly the disclosure relates to synchronization, conversion, and/or correlation of physiological data having timing information from physiological sensor(s) to timing information of external events, such as a simulation or training scenario or real-life situation.

### BACKGROUND

As advances in physiological sensors make them more minimally intrusive and easier to use, there is a clear desire by researchers in the fields of Augmented Cognition and Neuroergonomics to incorporate physiological sensors as much as possible, for example, for use in research efforts for subjective measurement of a subject's state and/or reactions. When developing a closed-loop adaptive system in which the system is changed based on feedback from within the system, the closed-loop adaptive system may be able to measure the workload and cognitive states of a subject accurately using multiple physiological date sensors and performance measures. To best support use of multiple measures, the data from each sensor must be accurately synchronized across all devices and tied to performance and/or environment events. However, each sensor provides different sampling frequencies, local timing information (for example, local time stamps), and timing accuracy (resolution) making data synchronization across disparate devices and other measurements (e.g. environment events) in logs or real time systems difficult. There currently exists an issue of how to synchronize data to support analysis of physiological with respect to performance measures and environmental events. These problems become even more pronounced when working within a distributed computing environment where multiple machines are used for different devices, tasks, and team members.

Currently several types of synchronization protocols and areas of study exist. One type of time synchronization is defined by the High Level Architecture (HLA). High-level architecture (HLA) is a general purpose architecture for distributed computer simulation systems. Using HLA, computer simulations can communicate data and synchronize actions with other computer simulations regardless of the computing platforms. However, HLA only relates to one clock to synchronize simulation data to simulation data, not physiological data.

Another type of time synchronization is Network Time Protocol (NTP). NTP is a networking protocol for synchronizing the clocks of computer systems over packet-switched, variable-latency data networks. NTP is based on Coordinated Universal Time (UTC). Robotics applications also synchronize data from multiple sensors to a global time frame, but not to an arbitrary time reference frame, and not in the domain of physiological sensors. Some current systems require the third party application data to be imported into another application for synchronization with a single sensor or single vendor's product. Some current systems, such as “Eyeworks” available from Eyetracking, Inc. of San Diego, Calif., are capable of synchronizing data from a single sensor with a computer-based simulation, but all timing information is specific to that application's time reference frame. These applications lack the ability to correlate physiological data to real-world events, timing is not convertible programmatically to new reference frames, and do not include data from other physiological sensors.

Current synchronization systems do not support synchronization with a third party application or time reference frame. The current systems require one single application to record simulation/training data alongside any other data, such as physiological data.

Additionally, the systems do not correlate physiological data with non-physiological data (e.g., data from an external event). Examples of external events include simulation and training scenario events as well as real-life situations. Some prior systems synchronize non-physiological data, such as audio or video or data from various sensors, but do not correlate such data with an external event. In practice, some sensors are started manually at the same time in order to attempt to match start times of the sensors. However, manual attempts at synchronizing sensor start events are lacking in accuracy because physiological changes in a subject may occur in the order of milliseconds, well below the accuracy possible by a manual synchronized start.

A need exists for systems and methods for synchronizing and correlating subject(s) physiological sensor data with non-physiological sensor data from external events and/or with external systems.

### SUMMARY

The following brief summary is not intended to be limiting as to the scope of the claims. Methods and systems are disclosed. The problem of synchronization and distribution of one or more physiological data, which reflects the state of a subject connected to physiological devices, with non-physiological data, such as that recorded for external events or environments, is addressed through correlation of time references of physiological and non-physiological data. More specifically, the physiological data includes a first time at which the physiological data was recorded, the first time being based on a global time frame reference. The non-physiological data also includes a second time, the second time being based on the global time frame reference. The system is adapted to generate physiological reaction data indicative of a physiological reaction of the subject to the external event by correlating the first and second times, for real time or post-hoc analysis. The systems and methods may be applied modularly to existing third party applications and environments.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 is a block diagram of an exemplary physiological sensor system having a physiological data collection system, an external event system, and an analysis system in accordance with the present disclosure.

FIG. 2 is an illustration of exemplary time frames in the exemplary physiological sensor system in accordance with the present disclosure.

FIG. 3A is a schematic of another exemplary physiological sensor system implemented as a distributed system with a first computer obtaining physiological data from a subject, and a second computer implementing the external event system and the analysis system to provide an environment, receive the filtered and/or unfiltered physiological data from the first computer, and analyze the filtered/unfiltered physiological data in accordance with the present disclosure.

FIG. 3B is another diagram of the distributed sensor physiological sensor system of FIG. 3A in which the environment is a computer simulation/training provided by the second computer.

FIG. 4 is a schematic diagram of another exemplary physiological sensor system for tracking eye movement, with a multi-filter system in accordance with an embodiment described in the present disclosure.

FIG. 5 is an exemplary computer display provided by the analysis system in accordance with an embodiment described in the present disclosure.

FIG. 6 is an illustration of an exemplary Fixed Window Epoch data format utilized by a filter of the physiological data collection system in accordance with an embodiment described in the present disclosure.

FIG. 7 is an illustration of an exemplary Rolling Window Epoch data format utilized by a filter of the physiological data collection system in accordance with an embodiment described in the present disclosure.

### DETAILED DESCRIPTION

The following detailed description refers to the accompanying drawings. The same reference numbers in different drawings may identify the same or similar elements.

The mechanisms proposed in this disclosure preferably circumvent the problems described above. The present disclosure describes methods and systems for synchronizing and correlating physiological data and non-physiological data, the non-physiological data based on an event or environment external to the subject from which the physiological data is gathered. An exemplary embodiment includes receiving, by circuitry of a computer, physiological data comprising physiological information gathered by a physiological sensor about a subject, the subject having physiological reactions to an event that is external to the subject, wherein at least one of the physiological data also comprises a first time at which the physiological data was recorded, wherein the first time is based on a global reference time frame; receiving, by circuitry of the computer, non-physiological data comprising information about the event that is external to the subject from which the physiological information is gathered, wherein at least one of the non-physiological data also comprises a second time at which the non-physiological data was recorded, wherein the second time is based on the global reference time frame; correlating, by circuitry of the computer, the physiological data with the non-physiological data based on the first and second times; and generating physiological reaction data indicative of a physiological reaction of the subject to the external event.

### DEFINITIONS

If used throughout the description and the drawings, the following short terms have the following meanings unless otherwise stated:

A physiological device in the context of this disclosure may be physical hardware which can gather raw physiological data from a subject such as a person or an animal. Examples of physiological devices include devices for tracking eye movement, facial position, Electro Dermal Response (EDR), Heart Rate Variability (HRV), and Electroencephalography (EEG).

A physiological sensor in the context of this disclosure may be hardware and/or software interfaced with the physiological device. In one embodiment, the physiological sensor may be one or more computer processors running software to receive, time stamp and store the raw physiological data from the physiological device.

A filter in the context of this disclosure may be hardware and/or software which may be used to manipulate the physiological data, for instance, the filter may process, analyze, add to, classify, narrow, or display physiological data.

UTC stands for Universal Coordinated Time. Universal Coordinated Time is a global time reference frame, that is, a time standard. UTC is based on International Atomic Time which includes time information of the Day, Hour, Minute, Second, and Millisecond. UTC time is used as the primary method for system time on most modern computer operating systems and networks.

Software includes one or more computer executable instructions organized into algorithms that when executed by one or more component cause the component to perform a specified function. It should be understood that the algorithms described herein are stored on one or more non-transient memory. Exemplary non-transient memory includes random access memory, read only memory, flash memory or the like.

A time stamp is a term for recording the time at which a physiological data point was recorded by a physiological sensor or at which the non-physiological data of the external event occurred.

### DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

Outside of physical devices, such as a monitor for providing an environment, sensors for collecting data regarding external events, and physiological devices for collecting physiological data, the methods and systems described herein will be implemented herein as a combination of software and computer hardware. The software and hardware may be carried out in a local or a distributed system or systems. Block diagrams may be used to describe methods and systems, but it should be understood that functionality described as being carried out by software and hardware may also be performed by one component or multiple components. Alternatively, functionality described as being carried out by multiple components may be performed by a single component. The methods and systems described herein may be executed as computer executable instructions which may be implemented by one or more computer processors and/or stored on one or more non-transitory computer-readable media.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

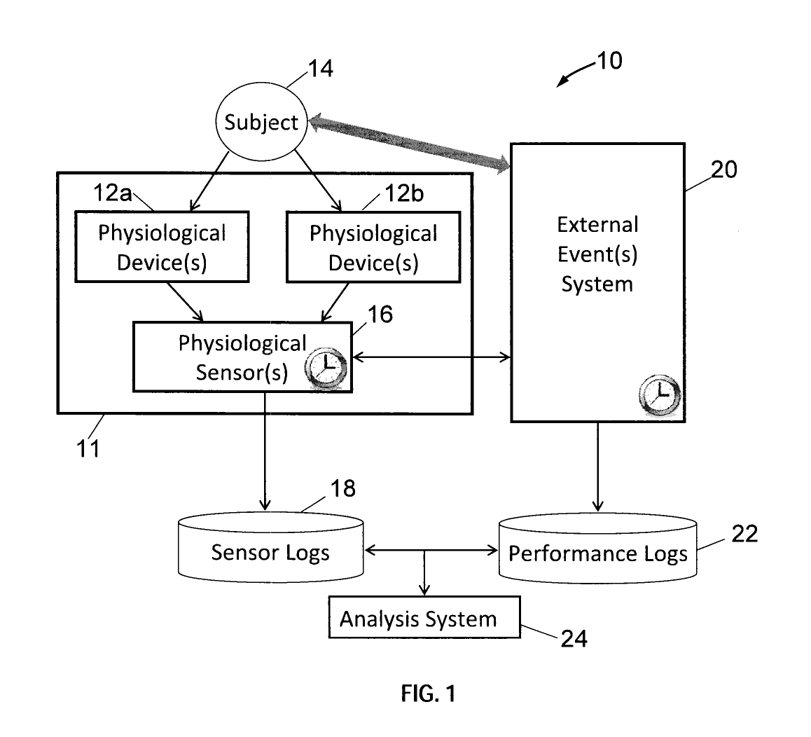

Referring now to the drawings, FIG. 1 is a block diagram of an exemplary physiological sensor system 10 in accordance with the present disclosure. The physiological sensor system 10 may be provided with a data collection system 11, which may include one or more physiological devices 12a and 12b which may collect raw physiological data from a subject 14, such as a person or animal, while the subject 14 is involved in, or exposed to, an external event or environment. The physiological devices 12a and 12b in the context of this disclosure may be physical hardware which can gather raw physiological data from the subject 14, such as a person or an animal. Examples of physiological devices 12a and 12b include devices for tracking eye movement, facial position, Electro Dermal Response (EDR), Heart Rate Variability (HRV), and Electroencephalography (EEG).

The data collection system 11 of the physiological sensor system 10 also includes a physiological sensor 16. The physiological sensor 16 may be software running on processor, which may interface with the physiological device(s) 12a and 12b with an analog to digital converter or other device that interfaces the physiological device 12a and/or 12b with the processor. The physiological sensor 16 in the context of this disclosure may be hardware and/or software interfaced with the physiological devices 12a and 12b. The physiological sensor 16 may manipulate the raw physiological data from the physiological device(s) 12a and 12b to collect, log, add to, convert, and/or analyze the raw physiological data.

Of course, it should be understood that the physiological device(s) 12a and 12b and the physiological sensor 16 may be separate components or embodied in a single component in any combination or number. For example, one physiological sensor 16 may manipulate the raw physiological data from two or more physiological devices 12a and 12b; the physiological sensor 16 may be encapsulated in the same hardware as a physiological device(s) 12a and 12b; two physiological devices 12a and 12b may be encapsulated in the same hardware as each other; etc. It should also be understood that physiological data may be gathered from more than one subject 14, for example, from a group or team or multiple individuals.

The physiological sensor(s) 16 may also record the Sensor Times for the physiological data, that is, the times that the physiological data was gathered from the subject 14. When time data is tracked and/or recorded at the same time that physiological data is gathered, rather than after the transferring of physiological data to be correlated, synchronized and/or analyzed, no additional timing error is introduced. It is important for a timestamp to be assigned at the moment the data is generated. By doing so, no additional inaccuracies in timing are added by the computational time required for processing, filtering and logging which would be included if the time stamp was added after the data was generated. The Sensor Times may be a relative time, based on the start time of the physiological device(s) 12a and 12b or the physiological sensor 16. The Sensor Times may also be an absolute time including at least one global reference time frame time (or time stamp), such as UTC time. Of course, it should be understood that any global reference time frame could be utilized. For example International Atomic Time (also known as TAI) could be utilized. For simplicity, the global reference time frame will be referred to herein as UTC time. The global reference time frame times may be recorded in any manner.

The physiological data from the physiological sensor 16 may be recorded, for instance, in Sensor Logs 18. The Sensor Time for the physiological data may also be recorded in the Sensor Logs 18.

The physiological sensor system 10 also includes an external event system 20 for providing and/or recording data of an event external to the subject 14. The event may be a live situation, a training event, a simulation, game or any external event to which the subject 14 whose physiological data is gathered is exposed or involved. The external event system 20 may optionally be provided with one or more perception devices that can provide signals that may be perceived by the subject. The perception devices, for example, may include an audio device (such as a speaker), a video device (such as a monitor), a movable device (such as a vibrator) and combinations thereof. Non-physiological data from the external event or environment may be tracked and/or recorded by the external event system 20 along with a Master Time. The external event system 20 may include one or more sensors for sensing the occurrence of the external event. The Master Time is a time frame aligned with the external event or environment. The Master Time may be a relative time, and/or may be based at least in part on a global reference time frame, such as UTC time. The Master Time may be recorded in any manner, including automatically, as is well known in the art, or manually.

The non-physiological data from the external event system 20 may be recorded, for instance, in Performance Logs 22. The Master Time for the non-physiological data may also be recorded in the Performance Logs 22. The Sensor Logs 18 and Performance Logs 22 can be implemented as data stored on a non-transitory memory in any suitable format, such as a binary format, a text format, a database format or the like. The data may be retrieved, viewed, and/or analyzed in an analysis system 24, which may be implemented as an application program running on one or more processors. The application program may include a spreadsheet program or a database program.

As discussed previously, multiple physiological sensors 16 may have different Sensor Times. Different physiological sensors 16 may have different sampling frequencies for data and Sensor Time. Additionally, the Master Time of the external event or environment likely will not match the Sensor Time(s). However, in order to analyze and/or act upon the physiological responses of the subject 14 to an external event or environment, a user may wish to match the time of an external event to the time of the subject 14's physiological reaction, i.e. the time of the physiological data, the Sensor Time.

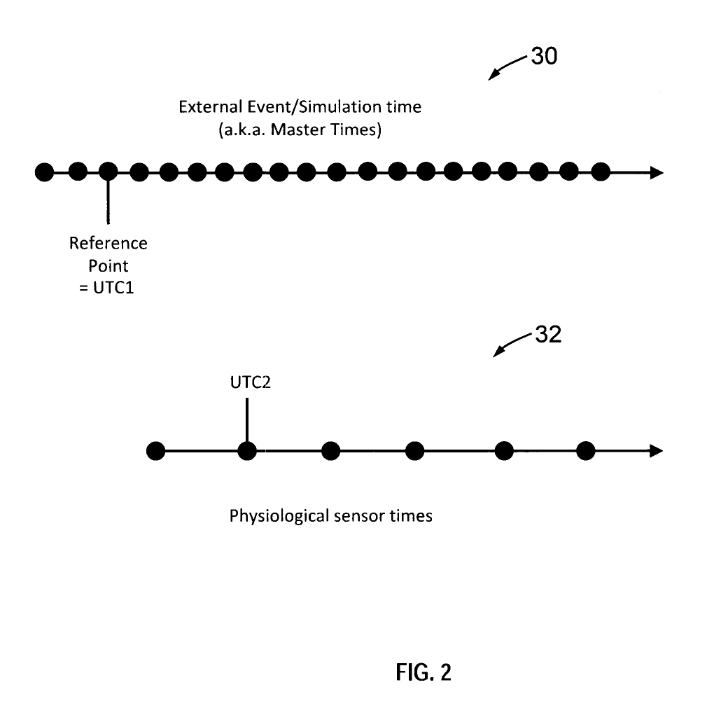

Referring now to FIG. 2, FIG. 2 is an illustration of exemplary time frames 30 and 32 in an exemplary environment in accordance with the present disclosure. As previously discussed, the Master Times may be tracked and/or recorded in conjunction with the external event or environment. Within the Master Times is at least one Reference Point which is shown as UTC1. The Reference Point UTC1 is a designated time point and may be designated as any time point occurring during the external event or environment time stream. For example, the Reference Point may be designated as a start time point or an end time point of the external event, or a pause time point in the external event or environment time stream. The Reference Point UTC1 may be identified at least by the global reference time frame time, such as UTC, at which time the Reference Point occurred, illustrated in FIG. 2 as UTC1.

Additionally, the Sensor Times may be tracked and/or recorded in conjunction with the physiological sensor as the physiological data is received by the physiological sensor. Within the Sensor Times is at least one Sensor Time which is identified at least by the global reference time frame time, such as UTC, at which time the Sensor Time occurred, illustrated in FIG. 2 as UTC2.

Global reference time frame times (such as UTC time stamps) may be automatically or manually recorded.

Master Time Service is a method and system for correlating and synchronizing the Sensor Times and the Master Times. Master Time Service may correlate the Sensor Times with the Master Times by utilizing the Reference Point global reference time frame time, illustrated as UTC1, and the Sensor Time identified by the global reference time frame time, illustrated as UTC2. The Master Time Service may calculate the difference between the global reference time frame times, UTC1 and UTC2. Then, using the calculated difference, the Master Time Service may calculate the global reference time frame time for any physiological data point and synchronize, i.e. match, the Sensor Time to the Master Time, thereby matching the physiological data time stream to the external event or environment time stream.

The Master Time Service or a related program may then generate physiological reaction data indicative of a physiological reaction of the subject 14 to the external event for any point in the external event time frame.

The physiological data from multiple physiological sensors 16 may be synchronized and correlated separately. For example, the physiological data from multiple physiological sensors 16 may be synchronized and correlated to each other. Additionally, or alternately, any number of physiological sensors 16 Sensor Time may be correlated to the Master Time of an external event or environment. Also, it should be understood that there may be multiple external events/environments from which non-physiological data may be captured, synchronized, and correlated.

The Master Time Service may synchronize data from multiple disparate physiological sensors 16, which update at different frequencies, with other third party data (e.g. simulation) using multiple time sources. Additionally, if the physiological sensor 16 provides a more accurate time stamp with the physiological sensor's data, the physiological sensor's time stamp information is also incorporated into the synchronization process for improved accuracy during analysis. If the physiological sensor 16 captures data at a higher frequency than the master time clock, then additional time differences are calculated between the sensor time and global reference point to interpolate time values.

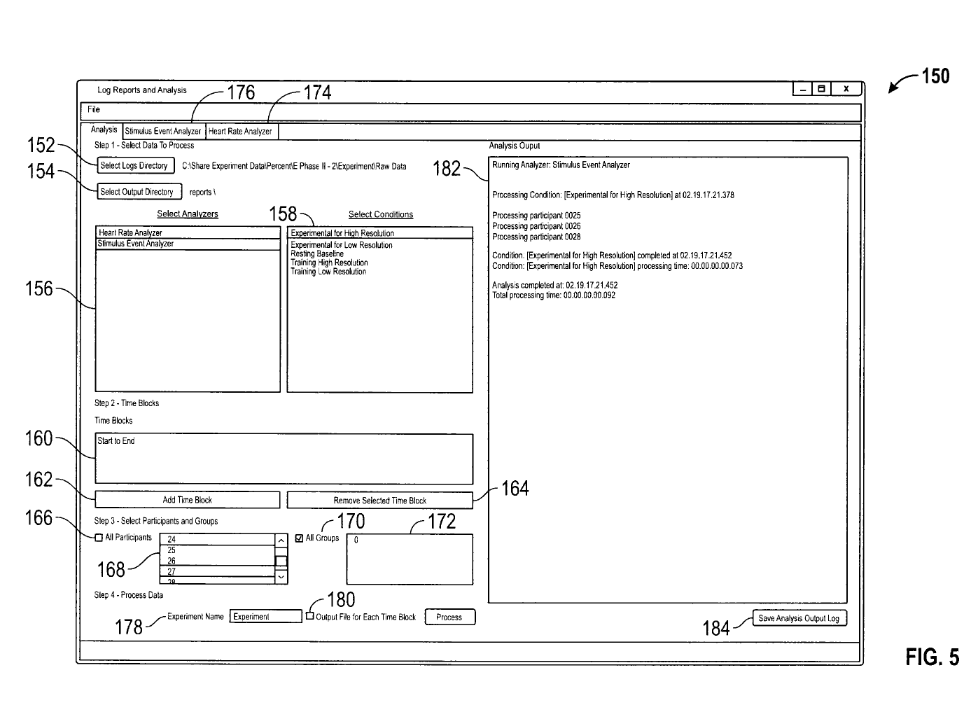

The Master Time Service may be implemented in software and/or hardware, and can be run in multiple places. 1) In the example of the program described with respect to FIG. 5, the Master Time Service may be a standalone application which reads the data logs (recordings) from Master Time and Sensor Time and synchronizes the time information. 2) The Master Time Service could exist within a simulation or training application that is receiving the Sensor data from a network or other inter-process communication technique and adjusting the timing in support of the closed-loop model described previously. It is assumed the Master Time data in this case is being generated within this application to be provided to the Master Time Service. 3) Master Time Service could also be a stand alone program that receives Master Time and Sensor Time data over a network connection or other means, performs correlation, and then shares the data back out over the network or other inter-process communication technique to other 3rd party systems.

The Master Time Service and the Sensor Logs 18 and Performance Logs 22 (collectively referred to as Data Logs) may execute and/or be stored in non-transitory memory of a local or distributed computer, computers, or computing systems. For example, the Master Time Service and Data Logs may be provided to a user in a distributed fashion, one such example is cloud computing. The Master Time Service may be provided as a modular add-in to third party applications and/or existing Data Logs.

As illustrated in FIG. 1, the physiological data and the non-physiological data may be communicated, correlated, and/or synchronized in real time. Also illustrated, additionally or alternatively, the physiological data and the non-physiological data may be communicated, correlated, and/or synchronized between the Sensor Log(s) 18 and Performance Log(s) 22 after an event.

Additionally, physiological data and external event or environment non-physiological data (for example, performance records) may be identified with additional unique identifiers. Examples of unique identifiers include User ID and Group ID. Using the unique identifiers, physiological sensor data for a specific subject 14 or group of subjects 14 may be isolated. The isolated data may be used for multiple purposes, such as analysis or for triggering changes in the external environment, for example, reassigning tasking to the subject 14 or subjects 14, or prompting the subject 14 to take an action.

In one example, a team of subjects 14 may be tasked in an external environment with supervising multiple unmanned ground reconnaissance and surveillance systems. Each team member may be required in this external environment to fulfill one or more specific tasks, for example, respond to audio and text communications, monitor video feeds, and/or re-route vehicles in response to circumstances. Physiological devices 12a and 12b may be used to measure physiological data of the subjects 14 in the team. For example, eye tracker devices may measure eye blink rate (EBR), pupil dilation (PD), and electroencephalography (EEG). In accordance with the present disclosure and further described above, the Master Time Service may correlate physiological data gathered from each of the team subjects 14 with physiological data gathered from other team subjects 14. The Master Time Service may also correlate the physiological data with non-physiological events/data in the external environment, for instance, an event of increased audio communications. The Master Time Service or a separate software program may then analyze the correlated physiological data and external event data to generate physiological reaction data indicative of a physiological reaction of the subject 14 to the external event. For example, the program may track an event of increased audio communications, correlate the event time to the physiological data times, and analyze the physiological data of the subjects 14 to determine if a team subject 14 is under a high workload condition (perhaps based on increased EEG and PD rates) while another team subject 14 is under a low workload condition (perhaps based on physiological rates that fall in a normal or low range). The software program may then trigger a change to the team subject 14 task assignments (e.g., mitigation) based on the data in order to even the workload conditions across the team subjects 14.

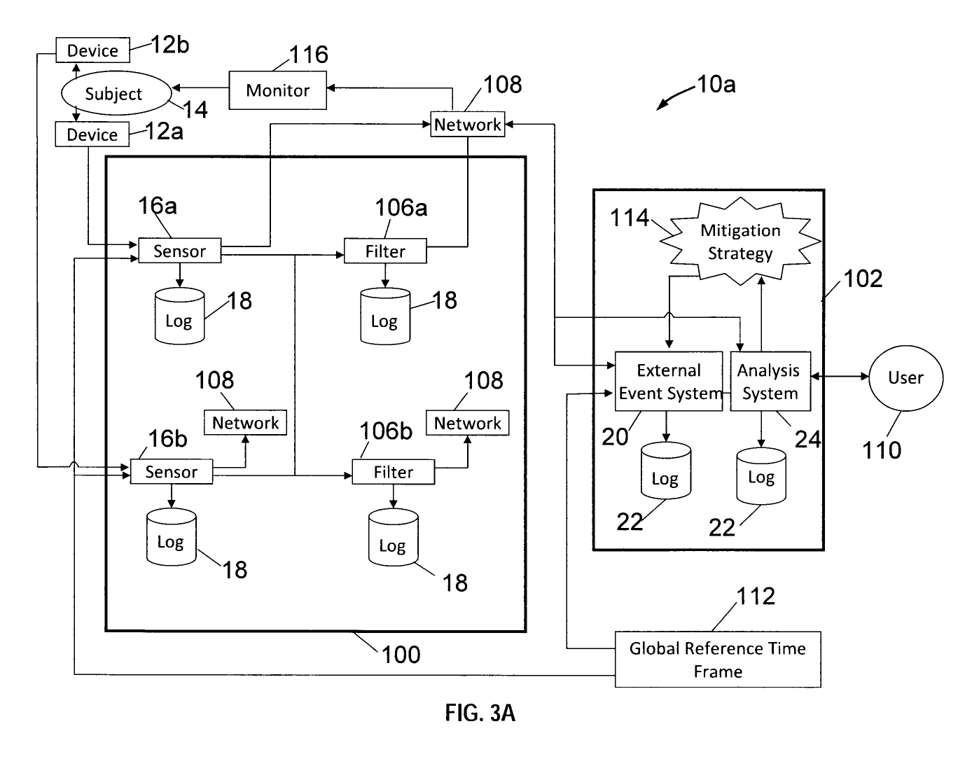

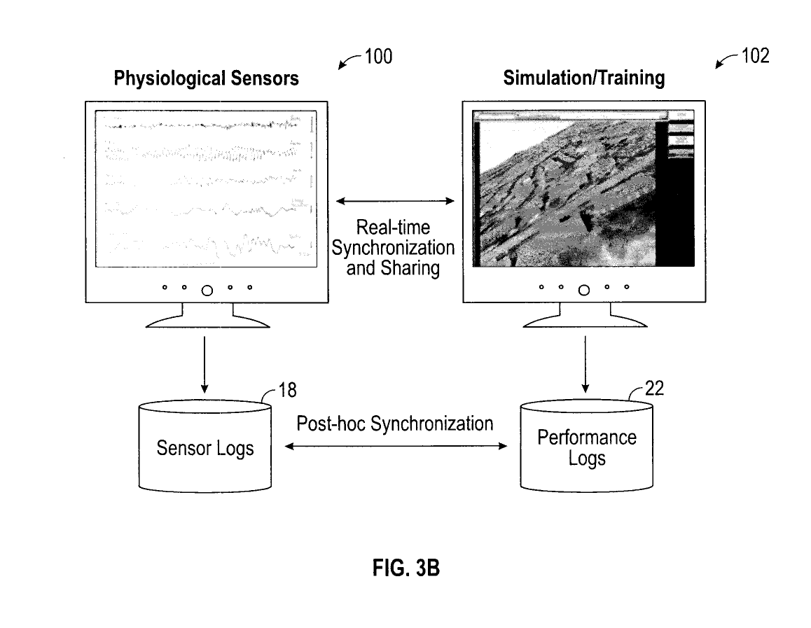

FIG. 3A is a schematic of another exemplary physiological sensor system 10a implemented with a first computer 100 obtaining physiological data from the subject 14, and a second computer 102 implementing the external event system 20 and the analysis system 24 to provide an environment, receive the filtered and/or unfiltered physiological data from the first computer 100, and analyzing the filtered/unfiltered physiological data in accordance with the present disclosure. In one embodiment, the first computer 100 runs a plurality of filters 106a and 106b to modify the physiological data in a predetermined manner. The filters 106a and 106b in the context of this disclosure may be hardware and/or software that may be used to manipulate the physiological data. For instance, the filters 106a and 106b may process, analyze, add to, classify, narrow, or display physiological data.

The physiological sensors 16a and 16b may communicate with other systems and devices, such as filters, utilizing a network 108, such as an internet, intranet, web, or any other distributed communication. The physiological sensors 16 may communicate with one or more Data Logs 18 and/or one or more filters 106a and/or 106b. The filters 106a and/or 106b may be used to manipulate the synchronized and correlated physiological data, and may be implemented as software or a software module. The filters 106a and/or 106b may be connected to a single physiological sensor 16 or to multiple physiological sensors 16a and 16b and/or to other filters 106. The filters 106a and/or 106b may produce new metrics or cleanup raw data from the physiological sensor(s) 16a and/or 16b. Connections between physiological sensors 16a and/or 16b and the filters 106a and/or 106b can be made within a software application or through subscriptions over a network connection.

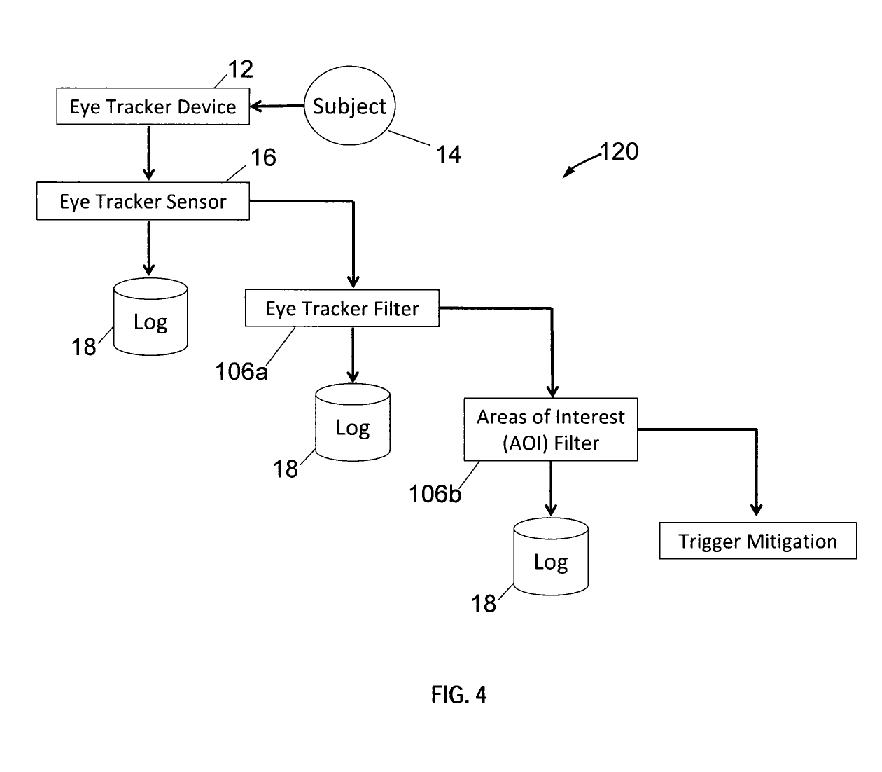

Filtering the synchronized data may be used to categorize and/or determine information about the subject 14. For example, using physiological data regarding eye movement from the physiological sensor 16a, the filter 106a may determine where the subject 14 is looking. The physiological sensor 16a and/or filter 106a may send physiological data or manipulated physiological data to data logs 18 and/or to the network 108 and/or make the data available for display to an end user (not shown). The filters 106a and/or 106b may be used to calculate and transmit only the metrics required by or requested by a third party data subscriber. A plurality of filters 106 in series are referred to herein as a Filter Graph as shown in FIG. 4.

The physiological data from the physiological sensors 16 and filters 106 may be synchronized with a global reference time frame, as described previously. The Master Time Service utilizing the global reference time frame may be applied across multiple computers and/or network(s), such as the computers 100 and 102 and network 108 illustrated in FIG. 3.

The computer 102 receives the synchronized and correlated physiological data (with or without filtering) and non-physiological data, and analyzes such data to create one or more mitigation strategies, as shown in FIG. 3. A mitigation strategy is an action taken based on the synchronized and correlated data, with or without additional categorization and can be accomplished in real-time. A mitigation strategy may include acting upon the subject 14, for example, decreasing a subject 14's interaction with the external environment. A mitigation strategy may include acting on the external environment, for example, changing a simulation exercise in which the subject 14 is participating.

Shown in FIG. 3A is another diagram of the physiological sensor system 10a in which the first computer 100 obtains physiological data from the subject 14, and the second computer 102 implements the external event system 20 and the analysis system 24 to provide an environment, receive the filtered and/or unfiltered physiological data from the first computer 100, and analyzes the filtered/unfiltered physiological data in accordance with the present disclosure. The first and second computers 100 and 102 communicate and work together to provide real-time synchronization and data sharing via the network 108 such that mitigation strategies can be used to alter the environment in real-time.

Shown in FIG. 4, is an exemplary sensor graph 120 in accordance with an embodiment of the present disclosure. As discussed above, the sensor graph 120 is formed by a plurality of filters 106a, 106b, and 106c in series. In the example of FIG. 4, the subject 14 is involved in an external environment, for instance, driving a vehicle which has the physiological sensor 16 in the form of an eye tracker device and eye tracker sensor. The eye tracker device and eye tracker sensor can be used to generate, track, and/or record raw data reflecting the subject 14's eye movement and amount of time the subject 14's eyes are directed away from the windshield view of the moving vehicle, for example, by gathering data on gaze location and/or pupil diameter. The eye tracker sensor data may include time data with the recorded physiological data. The time may be a relative time based on the sensor start point. Additionally, at least one UTC time for the physiological data may be recorded in a log or in software with the physiological data of the physiological sensor 16. The UTC time may be recorded once, for example, when the physiological sensor 16 (shown as Eye tracker sensor) starts tracking, then relative time of the physiological sensor 16 may be correlated with the UTC time to calculate UTC time for any data point in the physiological data. Alternatively or additionally, the UTC time may be recorded continually.

The physiological data from the physiological sensor 16, e.g., Eye Tracker Sensor may then be sent to an Eye Tracker Filter 106a. The Eye Tracker Filter 106a is an example of a data Filter which analyzes the raw physiological data received from the physiological sensor(s) 16 such as the Eye Tracker Sensor shown in FIG. 4. The Eye Tracker Filter 106a may produce classifications of the data. For example, the Eye Tracker Filter 106a may produce classifications such as fixations and workload, for example, Nearest-Neighbor Index.

Additionally, the physiological data may be sent to one or more additional filters 106b, such as an Areas of Interest (AOI) Filter illustrated in FIG. 4, creating a Filter Graph. The AOI Filter may be used to analyze the data including the data classified by the Filter and to trigger action based on that analysis. For example, in this example, the AOI Filter may analyze the classified physiological data indicative of eye gaze and eye pupil diameter against set norms for the subject 14 driving a vehicle.

The Master Time Service, as described previously, may be used to correlate the physiological data with the non-physiological data of the external environment, for this example, driving the vehicle. A program, which may be incorporated with the AOI Filter, may then use the correlation of the time data of the physiological data and the Master Time of the external event along with the AOI Filter analysis to determine that the physiological data of the subject 14 driving the vehicle is outside the norms, for example, the subject 14's gaze has been directed away from the vehicle windshield for a longer time than the norm. The AOI Filter or an additional program can then trigger a mitigation strategy. A mitigation strategy is an action that affects the subject 14 or the external environment. For example, one mitigation strategy may be to trigger the vehicle to slow or to sound alarms if the subject 14's gaze has been directed away for more time than the norm. Another mitigation strategy may be to directly alert the subject 14 driving the vehicle. Of course, mitigation strategies may be triggered directly from physiological sensors without use of a Filter.

It should also be understood that physiological sensors 16 and Filters 106 may be incorporated in separate entities or in the same entity, for example, the same software module or same program. The Filters 106 may be implemented in one device or multiple devices. The Filters 106 may be in a localized environment or a distributed environment.

In one embodiment, the AOI Filter may be used to analyze data after data is collected. For example, if the subject 14's vehicle was in a crash, the physiological data taken from the subject 14 could be classified and correlated with the Master Time of the external environment sequence of the vehicle crash and then could be used to analyze if the subject 14 had physiological states outside of the norm. For example, the UTC time the physiological data was taken indicating that the subject 14's gaze was directed away from the vehicle windshield for a greater time than the norm could be correlated with the UTC time at which the vehicle crashed, as recorded, for example, by systems within the vehicle and/or third party systems, such as external cameras.

FIG. 4 illustrates an exemplary system with two Filters in the system Filter Graph, however, it should be understood that any number of Filters or no Filters may be used.

The methods and systems described herein may be incorporated in software. The software may be adapted to run on any computing system, for example, a standard personal computer running Windows or Linux operating systems or a network central computer.

In one embodiment, the synchronization, correlation, and filtering, and triggering may be modular, that is, can be added to existing third party applications. For example, a third party experimenter may wish to correlate the physiological data from physiological sensors 16 of the subject 14 with an external environment, such as a video game, to determine when the subject 14 playing the video game has physiological changes in relation to occurrences in the game. The third party experimenter may use a global time reference frame to record a global reference time frame (such as UTC) time stamp for the video game events. The global time stamp can then be used to calculate the global time from the relative times recorded by the physiological sensor in conjunction with the physiological data. Then, the Master Time Service can be utilized (as described previously), using the global time reference to correlate the physiological data from each physiological sensor to the physiological data of other physiological sensors, and/or to correlate the physiological data from one or more physiological sensors to the non-physiological data global time stamps and related time references of the video game. The global time stamps of the non-physiological data of the video game events may be recorded automatically or manually. For instance, global time stamps may be recorded in a simple text file. Of course, any type of data record may be used, including third-party formats or software.

In one embodiment, a data table may be created in which a physiological sensor data point is associated with a UTC time at which the data point was generated or captured; a participant/subject 14 unique identification number for the participant/subject 14 associated with the data point; and a group/team unique identification number for the group/team with which the participant/subject 14 is associated. From these data, a datagram (that is, byte array structure) format may be created. The datagram format may be used for transmission of physiological sensor data and external environment data between computers in a distributed network. The physiological data along with the time data and unique identifiers that the physiological sensor 16 or Filter 106 produces can be logged and/or stored and transmitted in a datagram format for transmission to a user, another software program, and/or another computer. For example, the datagram format may include the fields shown in the following table:

| Field | Name | Description/Interpretation |
|---|---|---|
| 1 | Message Start | Four Byte value containing unique |
| | | identifiers for parsing message data |
| | | and bit flags for priority and |
| | | transmission confirmation |
| 2 | Time (UTC) | Four Byte UTC Time when this data |
| | | point was generated or captured by |
| | | source |
| 3 | Participant/User | One Byte Unique ID for the subject |
| | umber | 14/participant/user associated with the |
| | | data point |
| 4 | Group/Team Number | One Byte Unique ID for the group/team |
| | | of the subject 14/participant/user |
| | | associated with the data point |
| 5 | Sequence Number | Two Byte values representing the |
| | | sequence number for a multi-packet |
| | | sequence of data. First value always |
| | | starts at 0 and increases for each |
| | | packet in multi-packet stream. For |
| | | stand-alone packets value may be one. |
| 6 | Message Type | Two Byte Unique ID for the type of |
| | | message date included in payload |
| 7 | Message Payload | Two Byte integer representing size of |
| | Size | data in bytes |

In one embodiment, the “message start” field of the datagram may use the following format:

Message Start Format

| Bits | Name | Description |
|---|---|---|
| 0-7 | Start Byte | Byte representing the start of a |
| | | message. Value may be equal to 0x02 |
| 8-15 | Source Node ID | Unique Identifier representing the node |
| | | source of the message. A node is |
| | | defined as a PC or device with physical |
| | | interface. Valid values range from |
| | | [0,255] |
| 16-23 | Source Component ID | Unique Identifier representing the |
| | | source application on the node. This is |
| | | used to distinguish between multiple |
| | | applications on the same physical |
| | | source. Valid values range from |
| | | [0,255]. |
| 24 | Multi-Sequence | For example, if value is one, then this |
| | Message packet | packet is part of a multi-packet |
| | | sequence which is needed for |
| | | transmitting messages, greater than |
| | | maximum bytes per packet of transport |
| | | medium being used. The Sequence |
| | | Number field may be used for ordering |
| | | of data packets. If value is zero, then |
| | | the pack is stand alone and contains |
| | | the full message. |
| 25-32 | Reserved | Reserved bits for future expansion |

In one embodiment, the system may be used to assist in batch processing of experimental data collected. The system is able to index previously recorded data and extract overall metrics from different data source types and then aggregate the results for an entire group or sub-group of a subject 14 pool. FIG. 5 is an example of a display readable by a user adapted to be used by a user to select physiological data from physiological sensors 16 to correlate to recorded external events. The user is able to select the data the user wants to process as well as the location for output of the analyzed data. The display populates types of analysis that can be run and for what conditions.

Additionally, the system is adapted to allow a user to specify for what time periods in the external event or environment (such as a simulation time) analysis is desired, as shown by the Time Blocks section labeled Step 2 in FIG. 5. For example, the data from the entire time period of the external event may be chosen—as illustrated in FIG. 5 as “Start to End.” Or specific time periods within the external event can be added or removed with Add Time Block and Remove Selected Time Block functions. A user is able to specify the hour, minute, and second of the start and end of the time block occurring within the external event if desired.

The system is also adapted to allow the user to specify physiological data correlations from specific subjects 14 (participants) or groups of subjects 14, as illustrated in the section labeled Step 3—Select Participants and Groups.

Additionally, the system allows the user to specify which specific metrics should be reported from the data for a specific physiological sensor. For example, the illustrated Heart Rate Analyzer tab allows the user to select which Heart Rate Analyzer metrics the system will report, for instance, average inter-beat interval (IBI), Heart Rate, etc.

In one embodiment, the system allows users such as developers and researchers to easily integrate new physiological technologies and physiological devices into experiments creating uniform human readable log files that can be correlated to external events within live or virtual scenarios, and processed in bulk to reduce data processing times. Communication between processes and systems may be accomplished over TCP/IP and/or UDP/IP. The correlation may be done with “real-time” metrics, where real-time metrics are raw data points from a physiological sensor or an external event based on a period of data that is produced and shared as the data is available. For example, transmission of ECG signal or instantaneous heart rate inter-beat interval (IBI) to another program may be considered as in real-time. Also, heart rate variability calculated over a period of two minutes, with the resulting data shared at the end of that period, may also be considered real-time.

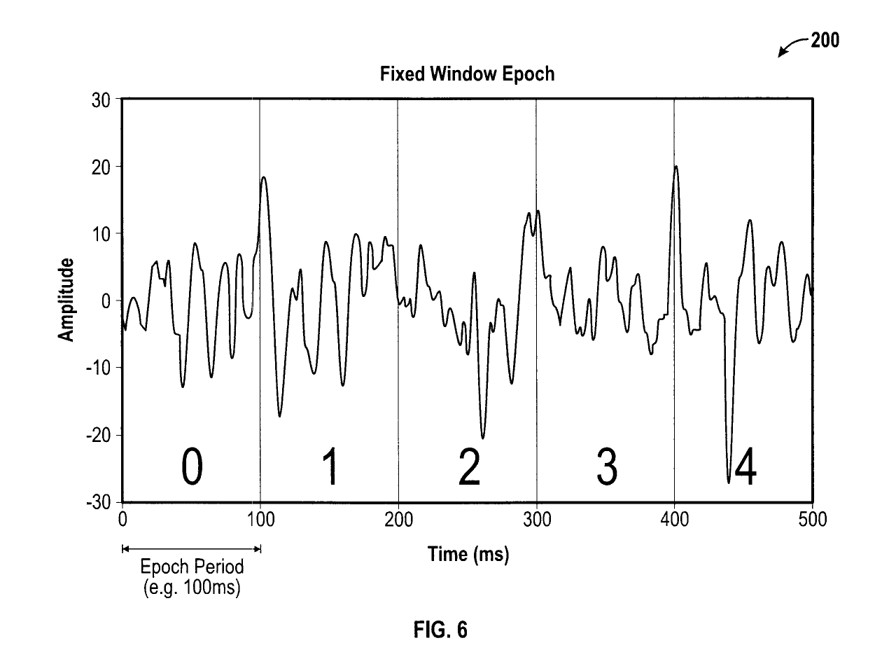

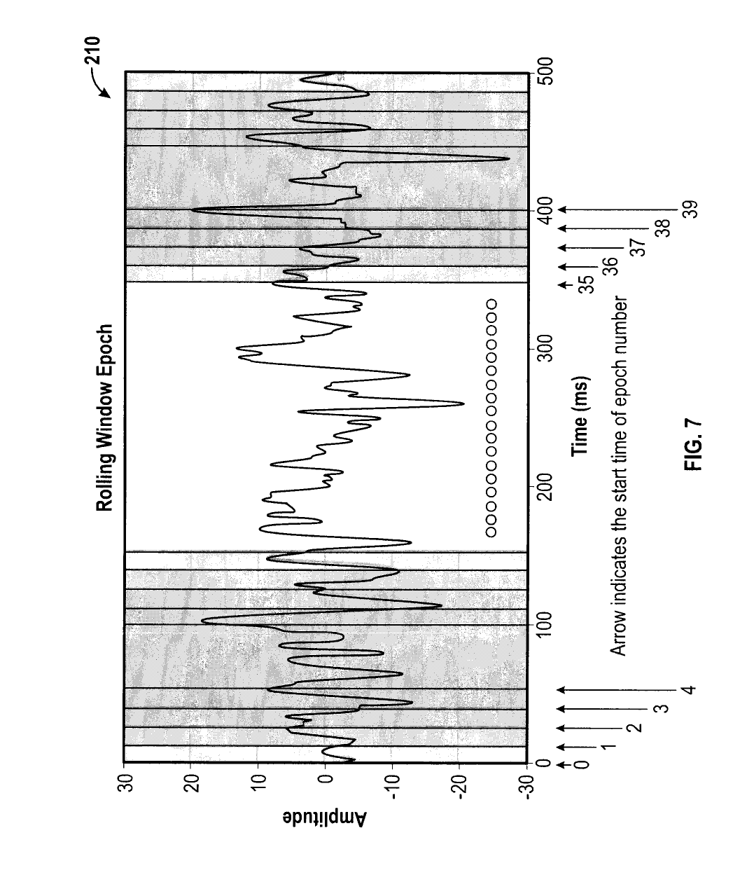

Real-time data may be parsed into epochs. A Fixed Window Epoch consists of windows of data with fixed period lengths in which the windows do not overlap from one epoch to the next. The start of the next epoch begins at the end of the previous epoch. FIG. 6 is an illustration of an exemplary Fixed Window Epoch format. In FIG. 6, epochs are numbered in sequential order with a starting index of zero to 65535 (two byte number). Once the maximum epoch is reached the epoch count is reset to zero. A Rolling Window Epoch consists of windows of data with fixed period lengths and overlaps with other windows. FIG. 7 is an illustration of an exemplary Rolling Window Epoch format.

The real-time data may be transmitted over a network connection using TCP/IP and/or UDP/IP. Data messages may be encoded into datagrams which may use a general transport message header, which contains information associated with a given session of data collection. Data may be stored in Little Endian byte format.

The user may choose to analyze real-time data by epochs. An exemplary fixed window epoch 200 is shown in FIG. 6. The exemplary fixed window epoch 200 has 5 time periods, each of which spans 100 ms and in which there is no overlap between each of the time periods. Shown in FIG. 7, on the other hand, is an exemplary rolling window epoch 210 having a plurality of time periods in which the time periods overlap.

One example of a generic message format for network streaming of real-time data using epochs is shown in the following table:

| | Data | | |
|---|---|---|---|
| Name | Type/Size | Optional | Description/Interpretation |
| Message | 4 Bytes | No | 4 Byte value containing unique |
| Start | | | identifiers for parsing message data |
| | | | and bit flags for priority, sequencing, |
| | | | and transmission confirmation. |
| User ID | UINT16 | No | Unique ID for the participant or user |
| | | | the data point is associated with. |
| | | | Value includes both participant and |
| | | | group ID numbers. Data is defined as |
| | | | follows: |
| | | | Bits: 0-13: Participant ID [0-16383] |
| | | | Bits: 14-15: Group ID [0-3] |
| Sequence | UINT16 | No | Sequence number for the packet |
| Number | | | data. Initial value is 0, and |
| | | | increments by 1 for each sequential |
| | | | packet transmitted from |
| | | | participant/group ID data source. |
| | | | When value hits 65535, it resets back |
| | | | to 0 on next increment. This value is |
| | | | used to keep track of ordered packets |
| | | | when dealing with multi-packet |
| | | | messages. |
| Message | UINT16 | No | Unique ID for the type of message |
| Type | | | data included in the payload (e.g. |
| | | | EEG, Heart Rate). |
| Global | UINT32 | No | 4 Byte UTC Timestamp representing |
| Timestamp | | | when the data point was generated or |
| | | | captured by the source. Data is |
| | | | defined as the following: |
| | | | Bits 0-9: milliseconds, [0,999] |
| | | | Bits 10-15: seconds, [0, 59] |
| | | | Bits 16-21: minutes, [0, 59] |
| | | | Bits 22-26: hour [0, 23] |
| | | | Bits 27-31: Day, [1,31] |
| Task/ | UINT32 | Yes | 4 Byte UTC Timestamp representing |
| Simulation | | | when the data point was generated or |
| Timestamp | | | captured by the source relative to the |
| | | | start of a task (e.g. simulation clock |
| | | | time). Bit field for presence of data is |
| | | | defined the example message start |
| | | | field format described below. |
| | | | Data is defined as the following: |
| | | | Bits 0-9: milliseconds, [0,999] |
| | | | Bits 10-15: seconds, [0, 59] |
| | | | Bits 16-21: minutes, [0, 59] |
| | | | Bits 22-26: hour [0, 23] |
| | | | Bits 27-31: Day, [1,31] |
| Epoch | UINT16 | Yes | Epoch number associated with the |
| | | | data. Epoch is an identifier number |
| | | | for the number of pre-defined |
| | | | periods of time that have elapsed. |
| | | | For example, if data metric requires |
| | | | 1 second of capture, and you get |
| | | | Epoch 3, then this data is the 3^{rd} |
| | | | data point. Epoch value resets to 1 |
| | | | when 65535 is reached. The period |
| | | | of time an Epoch represents is data |
| | | | driven, but can be calculated by |
| | | | looking at data time stamps. This |
| | | | field is optional and defined by |
| | | | the message start field format |
| | | | example below. |
| | | | (Message Start bit fields.) If not |
| | | | present, assume a value of 0. |
| Epoch | UINT16 | Yes | If Epoch number is present, than |
| Period | | | Epoch Period is also present. This |
| | | | value is a two byte unsigned short |
| | | | and represents the Epoch Period in |
| | | | seconds. |
| Message | UINT16 | No | The total size of the message |
| Payload | | | payload included with this packet, |
| Size | | | not including the header size in |
| | | | bytes, just data contents. |

One example of the “message start” field of the datagram may use the following format:

| | Data | | |
|---|---|---|---|
| Name | Type/Size | Optional | Description/Interpretation |
| Message Start | Bits 0-7 | No | Represents the start of a message |
| | | | and has a value of 0xFF. |
| Data Control | Bits 8-9 | No | Data control indicates if the packet is |
| | | | part of a multi-packet sequence. A |
| | | | value of 0 indicates a standalone |
| | | | (single) packet. 1 indicates 1^{st} in a |
| | | | series of packets, 2 is a normal |
| | | | packet in the series, and 3 |
| | | | represents the last packet in the |
| | | | sequence. |
| Epoch Data | Bits 10 | No | This field indicates if an Epoch |
| | | | number is included as part of the |
| | | | header. A value of 0 means no |
| | | | Epoch data, 1 indicates presence. |
| Task/Simulation | Bits 11 | No | If bit is 1, Task/Simulation Time is |
| Timestamp | | | present, 0 if not present. |
| Presence Bit | | | |
| Reserved | Bits 12-31 | No | Reserved for future growth, current |
| | | | values are 0. |

Examples have been provided herein for purposes of explanation. The examples are not to be construed as limiting the claims. Additionally, the examples may be permutated while still falling under the scope of the claims.

### CONCLUSION

Conventionally, physiological sensors and physiological data have been difficult to correlate with separate external events or environments. In accordance with the present disclosure, physiological data from subject 14(s), and non-physiological data from external events or environment to which the subject 14 is exposed, may be synchronized and correlated through the use of a global time reference frame and designated time points in the separate systems. Further, data may be manipulated, analyzed and/or acted upon in the external system, either in real-time or after data collection.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A method comprising the steps of:
receiving, by circuitry of a computer, physiological data comprising physiological information gathered by a physiological sensor regarding a subject, the subject having physiological reactions to an event that is external to the subject, wherein at least one of the physiological data also comprises a first time at which the physiological data was recorded, wherein the first time is based on a global reference time frame;
receiving, by circuitry of the computer, non-physiological data comprising information regarding the event that is external to the subject from which the physiological information is gathered, wherein at least one of the non-physiological data also comprises a second time at which the non-physiological data was recorded, wherein the second time is based on the global reference time frame;
correlating, by circuitry of the computer, the physiological data with the non-physiological data based on the first and second times; and
generating physiological reaction data indicative of a physiological reaction of the subject to the external event.

2. The method of claim 1, wherein the global reference time is Coordinated Universal Time.

3. The method of claim 1, further comprising the steps of:
filtering the physiological data such that the physiological data is categorized into classifications.

4. The method of claim 3 wherein the categorized physiological data is displayable to a user.

5. The method of claim 1, further comprising the steps of:
triggering at least one of an action to affect the event that is external to the subject from which the physiological information is gathered.

6. The method of claim 1, wherein the correlating at least one of the physiological data with at least one of the non-physiological data based on the global reference time frame of the physiological data and the non-physiological data occurs during the event that is external to the subject from which the physiological information is taken.

7. The method of claim 1, wherein the physiological data is received from a physiological data log.

8. The method of claim 1, wherein the physiological data is received from a physiological sensor.
